(19) United States
(12) Patent Application Publication
(10) Pub. No.: US 2008/0139040 A1
(43) Pub. Date: Jun. 12, 2008

(54) ASSEMBLY APPARATUS

(75) Inventors: Yih Chih HSU, Tainan City (TW); Shang Chia CHANG, Hsinchu City (TW); Jone Chiung HUANG, Kaohsiung City (TW); Jih SHEN Wen, Taipei Hsian (TW)

Correspondence Address: VOLENTINE & WHITT PLLC, ONE FREEDOM SQUARE, 11951 FREEDOM DRIVE SUITE 1260, RESTON, VA, 20190, US

(73) Assignee: INDUSTRIAL TECHNOLOGY RESEARCH INSTITUTE, Judung Township (TW)

(21) Appl. No.: 12/035,510

(22) Filed: Feb. 22, 2008

Related U.S. Application Data
(63) Continuation-in-part of application No. 11/322,423, filed on Jan. 3, 2006, now abandoned.

(30) Foreign Application Priority Data
Apr. 6, 2005 (TW) 094110821

(51) Int. Cl. H01R 4/26

(52) U.S. Cl. 439/419

(57) ABSTRACT

An assembly apparatus includes a master body, a slave body and a connecting device connecting the master body and the slave body. The connecting device includes a first conductor, a second conductor and an isolation material configured to electrically isolate the first conductor from the second conductor, wherein the second conductor has a first plug, a second plug and a diode electrically connecting the first plug and the second plug. The master body includes a master socket configured to receive the first plug and a master light-emitting device electrically connected to the master socket. The slave body includes a slave socket configured to receive the second plug and a slave light-emitting device electrically connected to the slave socket.

This application is a continuous-in-part application of and claims priority to application Ser. No. 11/322,423; the complete disclosure of which is incorporated herein by reference for all purposes.

### BACKGROUND OF THE INVENTION

(A) Field of the Invention

The present invention relates to a connecting device and an assembly apparatus using the same, and more particularly, to a connecting device capable of preventing disengagement due to abrasion and an assembly apparatus using the same.

(B) Description of the Related Art

FIG. 1 is a schematic diagram of an assembly component 10 according to the prior art. The assembly component 10 includes a bolt 12 and a sphere 20. The bolt 12 has an annular protrusion 14 at the end, and the size of the annular protrusion 14 is greater than that of the middle part 16 of the bolt 12. The spherical body 20 includes several openings 22 and an annular cove 24 in each opening 22. When assembling the bolt 12 and the spherical body 20, a user must apply force to squeeze the annular protrusion 14 of the bolt 12 into the annular cove 24 of the spherical body 20. Conversely, when disassembling the assembly component 10, the user must apply force to pull the annular protrusion 14 of the bolt 12 out from the annular cove 24 of the spherical body 20. Since one bolt 12 can connect two spherical bodies 20 and there are several openings 22 on one spherical body 20 to receive several bolts 12, engaging the annular protrusion 14 of the bolt 12 with the annular cove 24 of the spherical body 20 can constitute a variety of assembly components such as a molecular model.

The assembly component 10 is connected by the interference between the annular protrusion 14 and the annular cove 24, and therefore the relative size of the annular protrusion 14 and the annular cove 24 must be precisely controlled. Otherwise, the annular protrusion 14 cannot be squeezed into the opening 22, i.e., the annular protrusion 14 is too large, or the annular protrusion 14 cannot form a firm interference with the annular cove 24, i.e., the annular protrusion 14 is too small. In addition, after assembly and disassembly of the bolt 12 and the spherical body 20 has occurred a number of times, the annular protrusion 14 is likely to decrease in size due to abrasion, while the annular cove 24 is likely to broaden due to abrasion. As a result, the connection between the bolt 12 and the spherical body 20 tends to become loose.

### SUMMARY OF THE INVENTION

The present invention discloses a connecting device capable of preventing disengagement due to abrasion and an assembly apparatus using the same. The connecting device comprises a screw bolt with a hollow portion and a supporting member including a plurality of branches movably positioned in the hollow portion, wherein the branch includes a protrusion at one end and the size of the protrusion is larger than the size of the hollow portion. The present assembly apparatus comprises at least one body including a plurality of screw openings and at least one connecting device including a screw bolt capable of engaging with the screw opening.

Preferably, the body and the connecting device are made of plastic or metal. In addition, the body and the connecting device can optionally comprise a conductive portion, a light-emitting layer positioned on the surface of the conductive portion, and a passivation layer position on the surface of the light-emitting layer so as to form a light-emitting structure. Preferably, the conductive portion is made of silver, the light-emitting layer is made of an electroluminescent material such as zinc sulfide, and the passivation layer is made of polycarbonate.

Another aspect of the present invention discloses an assembly apparatus comprising a master body, a slave body and a connecting device connecting the master body and the slave body. The connecting device includes a first conductor, a second conductor and an isolation material configured to electrically isolate the first conductor from the second conductor, wherein the second conductor has a first plug, a second plug and a diode electrically connecting the first plug and the second plug. The master body includes a master socket configured to receive the first plug and a master light-emitting device electrically connected to the master socket. The slave body includes a slave socket configured to receive the second plug and a slave light-emitting device electrically connected to the slave socket.

Compared to the prior art, the body and the connecting device of the present assembly apparatus is connected by the engagement between the screw bolt and the screw opening to prevent the disengagement due to the abrasion of assembling and disassembling. In addition, the present assembly apparatus can optionally include the conductive portion, the light-emitting layer and the passivation layer to possess light-emitting ability.

### BRIEF DESCRIPTION OF THE DRAWINGS

The objectives and advantages of the present invention will become apparent upon reading the following description and upon reference to the accompanying drawings in which:

FIG. 1 is a schematic diagram of an assembly component according to the prior art;

FIGS. 2(a) and 2(b) illustrate a connecting device according to the first embodiment of the present invention;

FIG. 3 illustrates an assembly apparatus according to the first embodiment of the present invention;

FIG. 4 illustrates a connecting device according to the second embodiment of the present invention;

FIG. 5 illustrates a connecting device according to the third embodiment of the present invention;

FIG. 6 illustrates an assembly apparatus according to the second embodiment of the present invention;

FIG. 7(a) to FIG. 7(d) illustrates one application of the assembly apparatus as molecular models according to the present invention;

FIG. 8 illustrates one application of the assembly apparatus as a toy according to the present invention;

FIGS. 9(a) and 9(b) illustrates one application of the assembly apparatus as decorations according to the present invention;

FIGS. 10(a) and 10(b) illustrates one application of the assembly apparatus as an indication symbol or an advertisement symbol according to the present invention;

FIG. 11 illustrates an assembly apparatus according to one embodiment of the present invention;

FIG. 12 illustrates an assembly apparatus according to another embodiment of the present invention;

FIG. 13 illustrates an assembly apparatus according to another embodiment of the present invention;

FIG. 14 illustrates an assembly apparatus according to another embodiment of the present invention;

FIG. 15 illustrates one application of the assembly apparatus according to one embodiment of the present invention; and

FIG. 16 illustrates one application of the assembly apparatus according to another embodiment of the present invention.

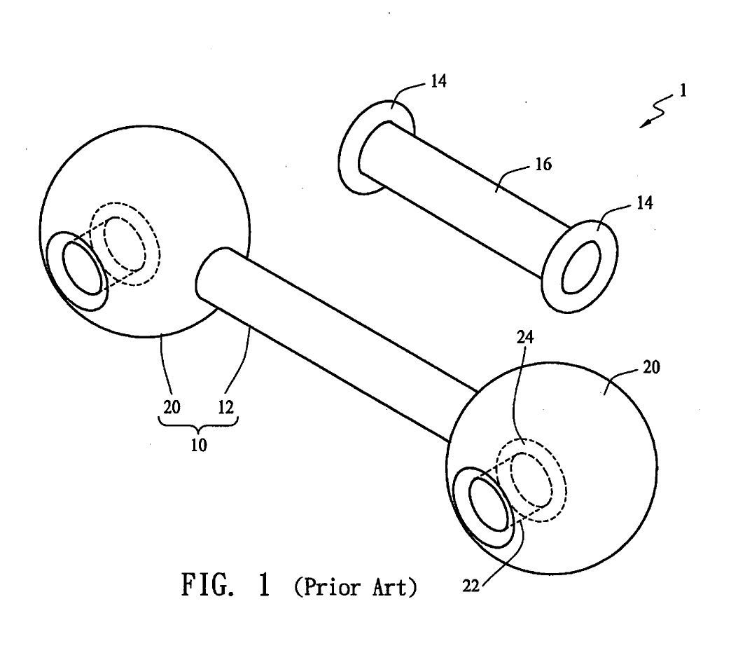

### DETAILED DESCRIPTION OF THE INVENTION

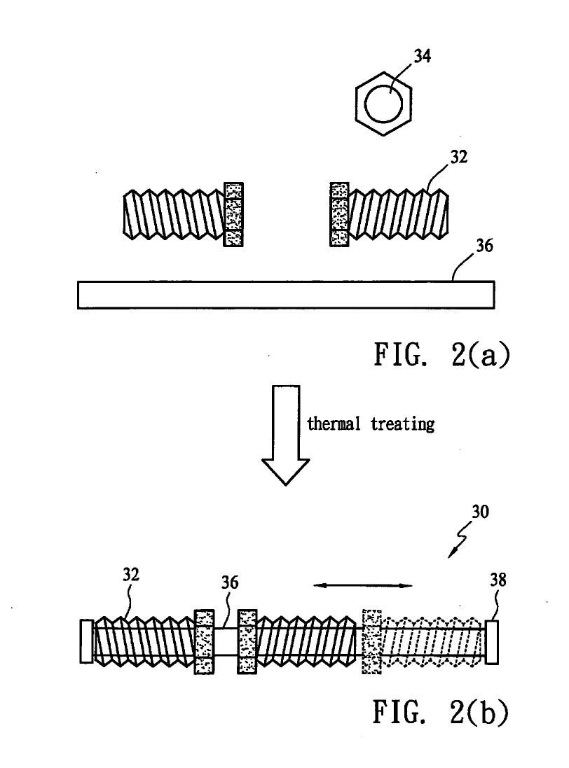

FIGS. 2(a) and 2(b) illustrate a connecting device 30 according to the first embodiment of the present invention. The connecting device 30 comprises two screw bolts 32 including a hollow portion 34 and a supporting member 36 movably positioned in the hollow portion 34, wherein the supporting member 36 includes a protrusion 38 at one end and the size of the protrusion 38 is larger than the size of the hollow portion 34. The method for preparing the connecting device 30 includes first placing the supporting member 36 in the hollow portion 34 of the screw bolt 32, then performing a thermal treating process to soften the end of the supporting member 36, and applying a certain force to the end inwardly to form the protrusion 38. The protrusion 38 can prevent the screw bolt 32 from disengaging out of the supporting member 36, while the screw bolt 32 is allowed to move between the two protrusions 38, as shown in FIG. 2(b). Preferably, the screw bolt 32 and the supporting member 36 are made of plastic or metal.

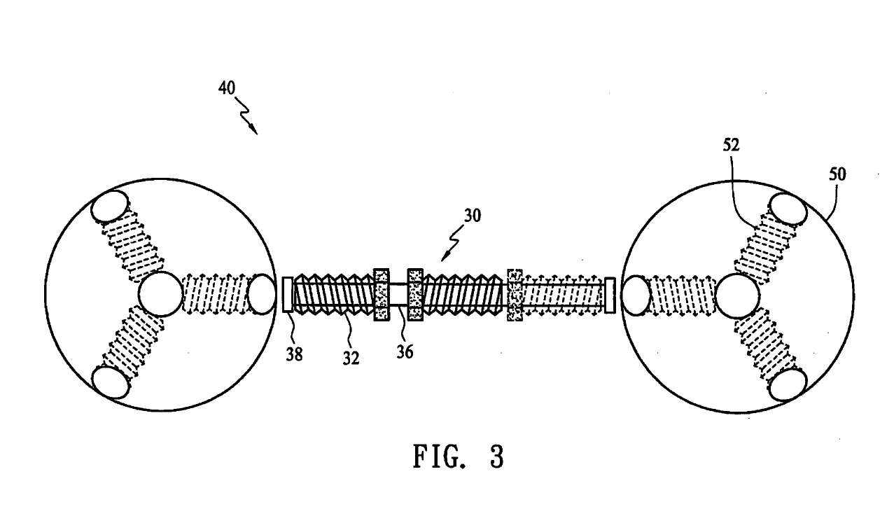

FIG. 3 illustrates an assembly apparatus 40 according to the first embodiment of the present invention. The assembly apparatus 40 comprises a spherical body 50 including a plurality of screw openings 52 and a connecting device 30 including a screw bolt 32 capable of engaging with the screw opening 52. The number and position of the screw opening 52 in the spherical body 50 can be designed based on the desired model or application. Preferably, the connecting device 30 and the spherical body 50 are made of metal or plastic. The assembly apparatus 40 is built by engaging the screw bolt 32 with the screw opening 52 to connect the connecting device 30 and the spherical body 50. Since the connecting device 30 possesses two screw bolts 32 capable of moving on the supporting member 36, engaging the left screw bolt 32 into a screw opening 52 in the left spherical body 50 does not simultaneously drive the supporting member 36, and the screw bolt 32 and the spherical body 50 at the right side stay at its position. In other words, the engagement between the left screw bolt 32 and the screw opening 52 in the left spherical body 50 is independent of that between the right screw bolt 32 and the screw opening 52 in the right spherical body 50 since the supporting member 36 is positioned in the hollow position 34 of the screw bolt 32.

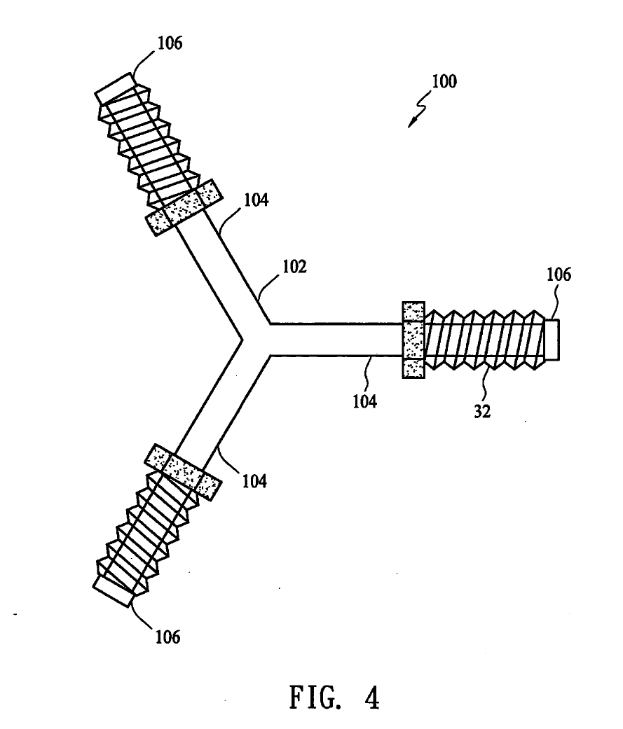

FIG. 4 illustrates a connecting device 100 according to the second embodiment of the present invention. The supporting member 102 of the connecting device 100 comprises three branches 104 separated by 120 degrees, and each branch 104 includes a protrusion 106 at the end and supports one screw bolt 32. Compared to the connecting device 30 in FIG. 2, which can connect only two spherical bodies 50, the connecting device 100 in FIG. 4 can connect three spherical bodies 50 by the three screw bolts 32 on the three branches 104. Particularly, the connecting device 30 in FIG. 2 can be regarded as including two branches separated by 180 degrees.

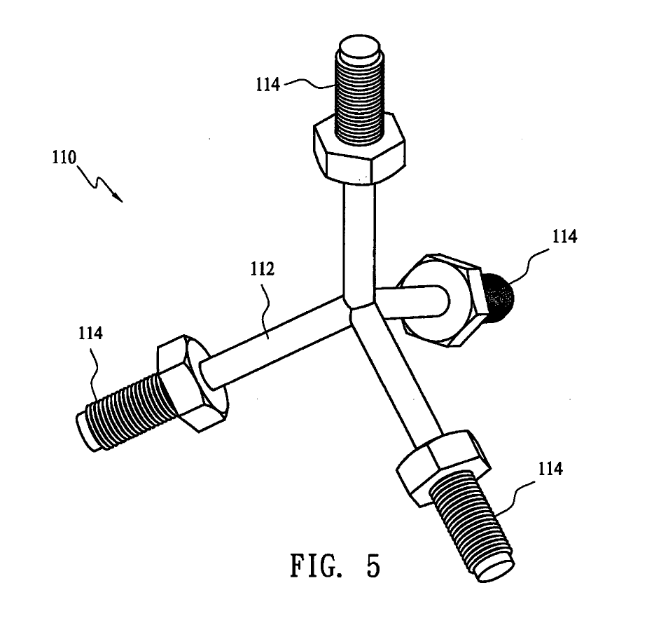

FIG. 5 illustrates a connecting device 110 according to the third embodiment of the present invention. Compared to the connecting device 30 in FIG. 2 and the connecting device 100 in FIG. 4, which possess several branches on the same plane, the supporting member 112 of the connecting device 110 in FIG. 5 includes four branches 114 separated by 109.5 degrees in three-dimensional space. The connecting device 30 in FIG. 2 can only connect two spherical bodies 50, but the connecting device 110 in FIG. 5 can connect four spherical bodies 50 by four screw bolts 32 on four branches 114.

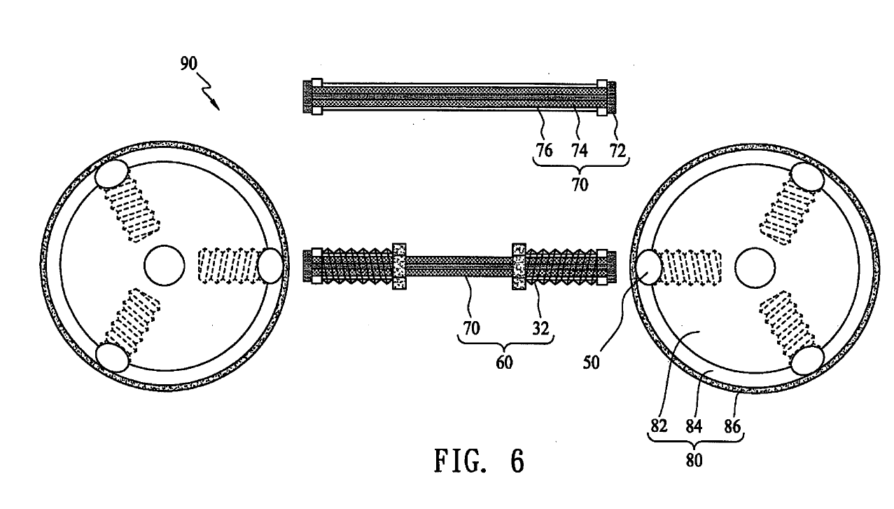

FIG. 6 illustrates an assembly apparatus 90 including a connecting device 60 and two spherical bodies 80 according to the second embodiment of the present invention. The connecting device 60 comprises a supporting member 70 and two screw bolts 32, wherein the supporting member 70 includes a conductive portion 72, a light-emitting layer 74 positioned on the surface of the conductive portion 72, and a passivation layer 76 positioned on the surface of the light-emitting layer 74. Preferably, the conductive portion 72 is made of silver, the light-emitting layer 74 is made of an electroluminescent material such as zinc sulfide, and the passivation layer 76 is made of polycarbonate. Similarly, the connecting device 100 in FIG. 4 and the connecting device 110 in FIG. 5 can optionally include the above-mentioned conductive portion, light-emitting layer and passivation layer.

The spherical body 80 comprises a conductive portion 82, a light-emitting layer 84 positioned on the surface of the conductive portion 82, a passivation layer 86 positioned on the surface of the light-emitting layer 84, and a plurality of screw openings 58. If a different shape is desired, the spherical body 80 can be made in cylindrical, cubic, or polyhedral shapes. Preferably, the conductive portion 82 is made of silver, the light-emitting layer 84 is made of an electroluminescent material such as zinc sulfide, and the passivation layer 86 is made of polycarbonate. The assembly apparatus 90 is built by engaging the screw bolt 32 with the screw opening 52 to connect the connecting device 60 and the spherical body 80. The assembly apparatus 90 can emit electroluminescence by applying current to the conductive portion 70 of the connecting device 60.

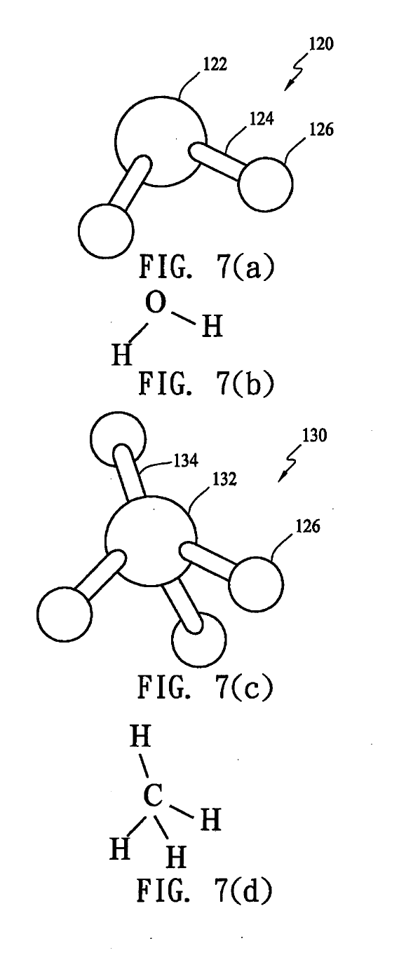

FIG. 7(a) to FIG. 7(d) illustrates one application of the assembly apparatus as a molecular model according to the present invention. A water molecular (H₂O) model 120 is built by engaging two connecting device 124 with one spherical body 122 including two openings and with two spherical bodies 126 including one opening, as shown in FIG. 7(a) and FIG. 7(b). Similarly, a methane molecular (CH₄) model 130 is built by engaging four connecting device 134 with one spherical body 132 including four openings and with four spherical bodies 126 including one opening, as shown in FIG. 7(c) and FIG. 7(d). Similarly, a variety of molecular models can be built by engaging the connecting device representing the bonding and the body representing the atom.

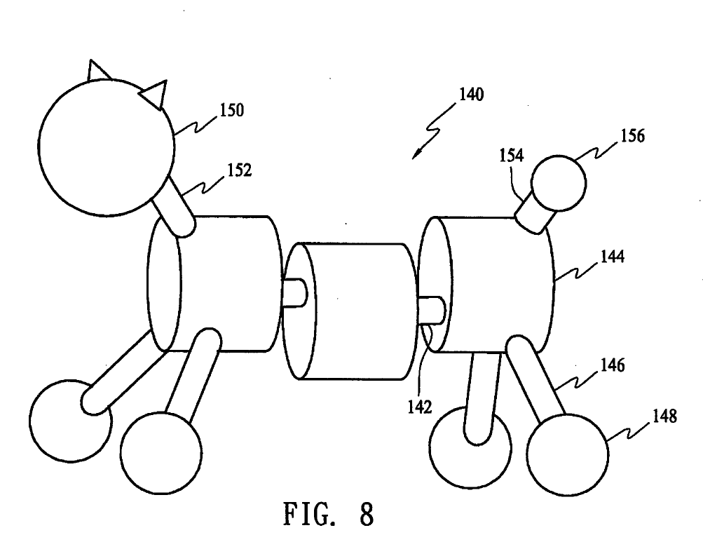

FIG. 8 illustrates one application of the assembly apparatus as a toy according to the present invention. A Doberman dog 140 is built by engaging two connecting devices 142 with three cylindrical bodies 144 to form the dog body, engaging four connecting devices 146 with four spherical bodies 148 and the cylindrical body 144 to form limbs, engaging a connecting device 152 with a spherical body 150 and the cylindrical body 144 to form the head, and engaging a connecting device 154 with a spherical body 156 and the cylindrical body 144 to form the tail. Similarly, a variety of toys can be built by engaging the connecting device with different length and the body with different shape.

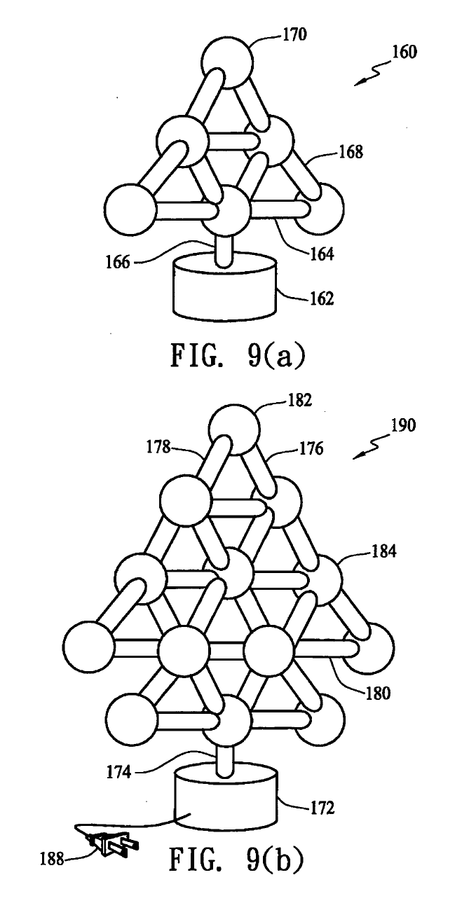

FIGS. 9(a) and 9(b) illustrates one application of the assembly apparatus as a decoration according to the present invention. A cylindrical body 162 is used as a base, and several connecting devices 164, 166 and 168 with different colors are used to engage several spherical bodies 170 with different openings to build a tree decoration 160, as shown in FIG. 9(a). In addition, a cylindrical body 172 including a light-emitting layer is used as a base connected to a commercial power supply via a plug 188, and several connecting devices 174, 176, 178 and 180 capable of emitting different colors are used to engage several spherical bodies 182 and 184 capable of emitting different colors to build an illuminating tree decoration 190, as shown in FIG. 9(b). Similarly, a variety of illuminating decorations can be built by engaging the connecting device capable of emitting different color and the body capable of emitting different color.

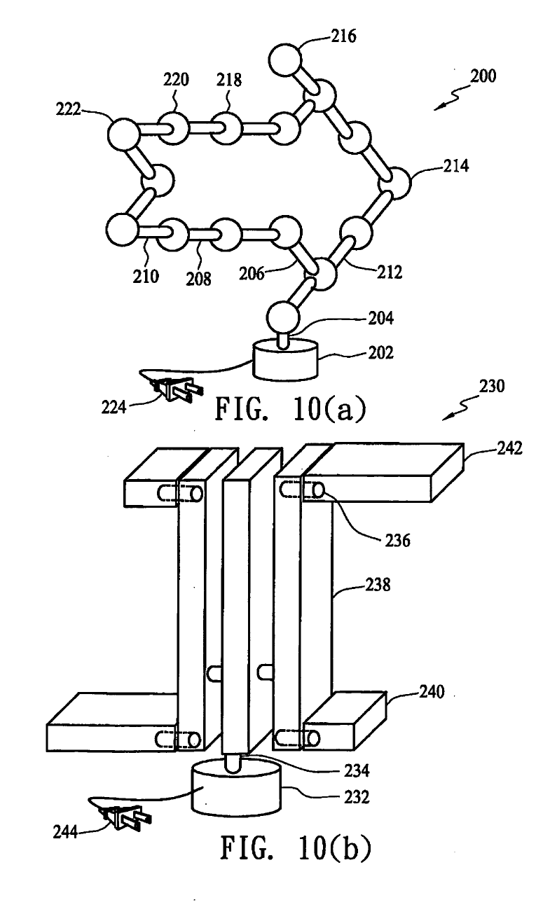

FIGS. 10(a) and 10(b) illustrates one application of the assembly apparatus as an indication symbol 200 or an advertisement symbol 230 according to the present invention. A cylindrical body 202 including a light-emitting layer is used as a base connected to a commercial power supply via a plug 224, and several connecting devices 204, 206, 208, 210 and 212 capable of emitting different color are used to engage with several spherical bodies 214, 216, 218, 220 and 222 capable of emitting different color to build the indication symbol 200, as shown in FIG. 10(a). Further, a cylindrical body 232 including a light-emitting layer is used as a base connected to a commercial power supply via a plug 244, and several connecting devices 234 and 236 capable of emitting different color are used to engage with several rectangular bodies 238, 240 and 242 capable of emitting different color to build the advertisement symbol 230, as shown in FIG. 10 (b). In short, a variety of indication symbols or advertisement symbols can be built by assembling the connecting device and the body including a light-emitting layer according to a predetermined structure.

Compared to the prior art, the body and the connecting device of the present assembly apparatus is connected by the engagement between the screw bolt and the screw opening to prevent the disengagement due to the abrasion of assembling and disassembling. In addition, the present assembly apparatus can optionally include the conductive portion, the light-emitting layer and the passivation layer to possess light-emitting ability.

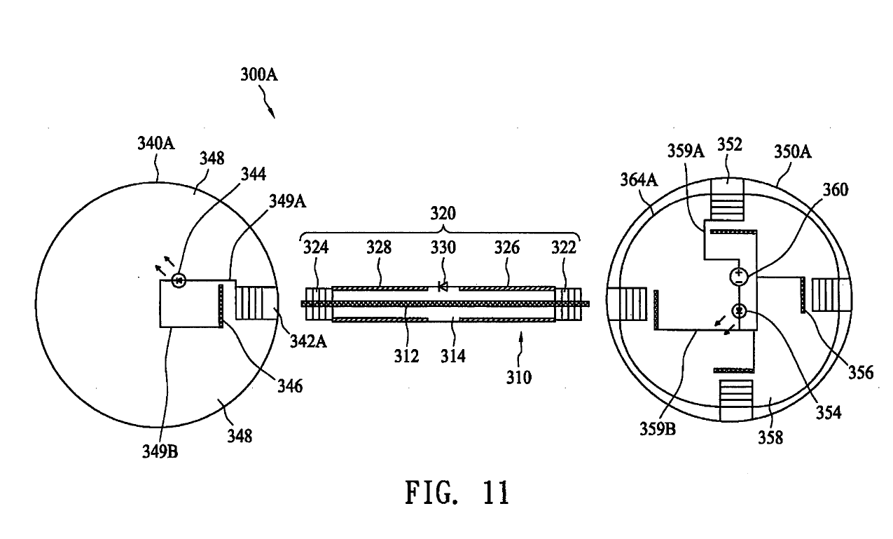

FIG. 11 illustrates an assembly apparatus 300A according to one embodiment of the present invention. The assembly apparatus 300A comprises a master body 350A, a slave body 340A and a connecting device 310 connecting the master body 350A and the slave body 340A. The connecting device 310 includes a first conductor 312, a second conductor 320 and an isolation material 314 configured to electrically isolate the first conductor 312 from the second conductor 320, wherein the second conductor 320 has a first plug 322, a second plug 324 and a diode 330 electrically connecting the first plug 322 and the second plug 324. The master body 350A includes a plurality of master sockets 352 configured to receive the first plug 322 and a master light-emitting device 354 such as a light-emitting diode electrically connected to the master socket 352. The slave body 340A includes a slave socket 342A configured to receive the second plug 324 and a slave light-emitting device 344 such as a light-emitting diode electrically connected to the slave socket 342.

The second conductor 320 of the connecting device 310 preferably has a first conductive block 326 connecting the first plug 322 to one terminal of the diode 330 and a second conductive block 328 connecting the second plug 324 to another terminal of the diode 330. In addition, the first conductor 312 can be a conductive core, while the first conductive block 326 and the second conductive block 328 can be conductive shells. Furthermore, the first plug 322 and the second plug 324 may be designed to be screw bolts, and the master socket 352 and slave socket 342A may be designed to be screw openings.

The slave body 340A includes a first conductive wire 349A connecting the slave socket 342A to one end of the slave light-emitting device 344, a conductive sheet 346 configured to contact the first conductor 312 of the connecting device 310 when the slave socket 342A receives the second plug 324, and a second conductive wire 349B connecting the conductive sheet 346 to another end of the slave light-emitting device 344. In particular, the slave body 340A is filled with isolation material 348 to electrically isolate the conductive members from each other.

The master body 350A includes a first conductive wire 359A connecting the master socket 352 to one end of the master light-emitting device 354, a plurality of conductive sheets 356 configured to contact the first conductor 312 of the connecting device 310 when the master socket 352 receives the first plug 322, and a second conductive wire 359B connecting the conductive sheet 356 to another end of the master light-emitting device 354. In addition, the master body 350A includes a power supply 360 electrically connected to the master light-emitting device 354, and a third conductive wire 364A connecting the master sockets 352 together.

Consequently, the master sockets 352 are connected to the master light-emitting device 354 and the power supply 360 in parallel, and the master light-emitting device 354 and the slave light-emitting device 344 will emit light as the connecting device 310 is used to connect the master body 350A and the slave body 340A. In particular, the master body 350A is filled with isolation material 358 to electrically isolate the conductive members from each other.

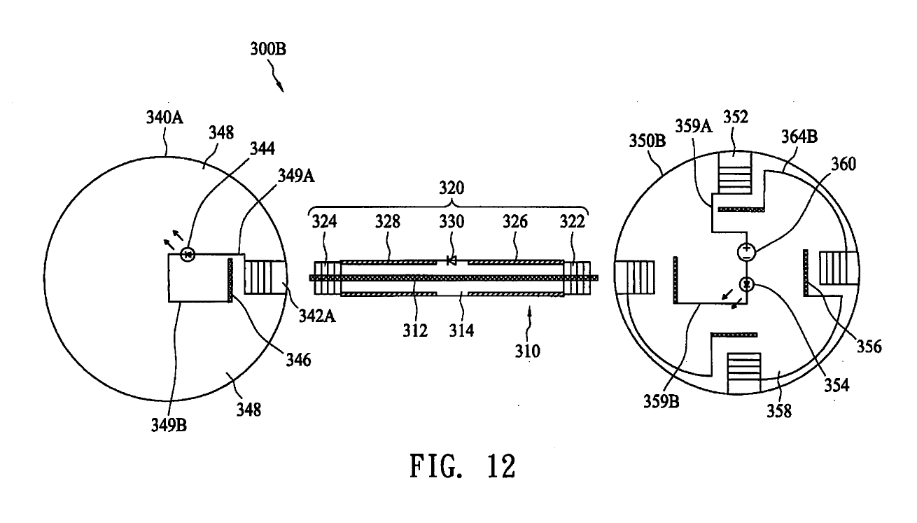

FIG. 12 illustrates an assembly apparatus 300B according to another embodiment of the present invention. Compared with the assembly apparatus 300A in FIG. 11 having the master sockets 352 of the master body 350A connected to the master light-emitting device 354 and the power supply 360 in parallel, the assembly apparatus 300B has the master sockets 352 of the master body 350B connected to the master light-emitting device 354 and the power supply 360 in series. In particular, the master body 350B includes a third conductive wire 364B connecting one master socket 352 to one of the conductive sheets 356 for another master socket 352, which is different from the master body 350A using the third conductive wire 364A connecting these master sockets 352 together. Since the master sockets 352 of the master body 350B are connected to the master light-emitting device 354 and the power supply 360 in series, the master light-emitting device 360 will not emit light until the master sockets 352 are all correctly connected to the corresponding conductive sheets 356 by the connection device 310 and the slave body 340A.

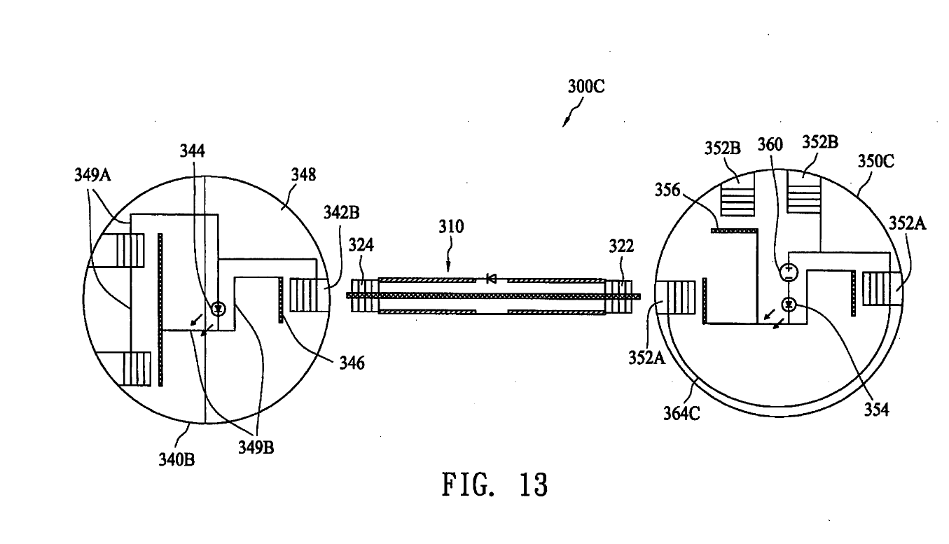

FIG. 13 illustrates an assembly apparatus 300C according to another embodiment of the present invention. The master body 350C of the assembly apparatus 300C includes two first master sockets 352A connected to the master light-emitting device 354 and the power supply 360 in parallel, a plurality of second master sockets 352B connected to the master light-emitting device 354 and the power supply 360 in series, and a third conductive wire 364C connecting the two first master sockets 352A. In addition, the slave body 340B of the assembly apparatus 300C includes a plurality of slave sockets 342B connected to the slave light-emitting device 344 in parallel. Consequently, the master light-emitting device 354 and the slave light-emitting device 344 will emit light as the connecting device 310 is used to connect the master socket 351A of the master body 350C and the slave socket 342B of the slave body 340B.

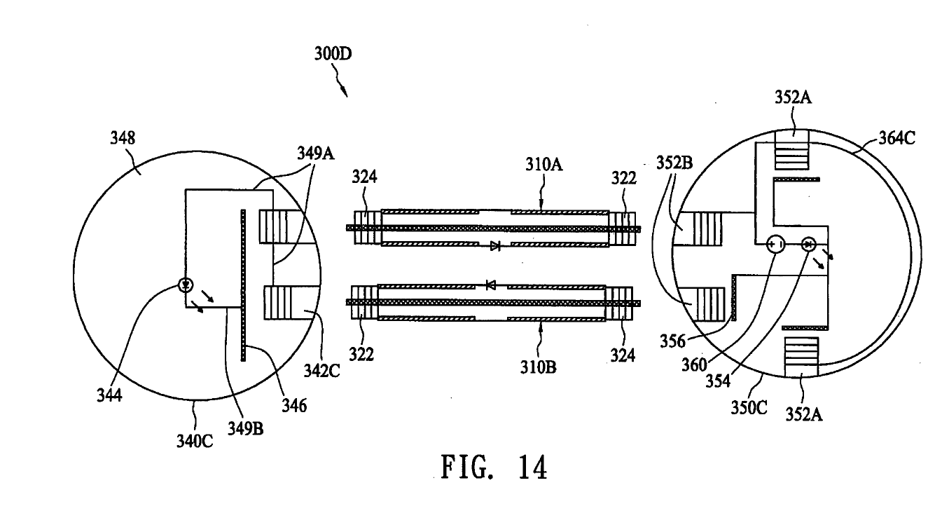

FIG. 14 illustrates an assembly apparatus 300D according to another embodiment of the present invention. The slave body 340C of the assembly apparatus 300D includes a plurality of slave sockets 342C connected to the slave light-emitting device 344 in series, and two connecting devices 310A, 310B are used to connect the slave sockets 342C of the slave body 340C to the second master sockets 352B of the master body 350C. Since the slave sockets 342C of the slave body 340C are connected to the slave light-emitting device 344 in series and the second master sockets 352B of the master body 350C are connected to the master light-emitting device 354 and the power supply 360 in series, the master light-emitting device 354 and the slave light-emitting device 344 will not emit light until the two connecting devices 310A, 310B are correctly used to connect the slave body 340C and the master body 350C.

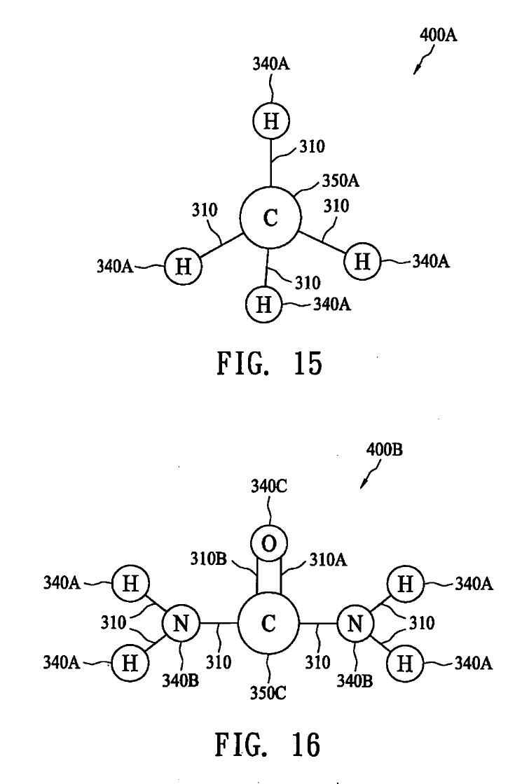

FIG. 15 illustrates one application of the assembly apparatus 300A according to one embodiment of the present invention. A model of a methane (CH₄) molecule 400A is built by engaging four connecting devices 320, one master body 350A and four slave bodies 340A. The master body 350A represents the carbon atom, the slave bodies 340A represent the hydrogen atoms, and the connecting devices 320 represent the chemical bonds connecting the carbon atom and the hydrogen atoms. Since the master sockets 352 of the master body 350A are connected to the master light-emitting device 354 and the power supply 360 in parallel, the master light-emitting device 354 and the slave light-emitting device 344 will emit light as the connecting device 310 is used to connect the master body 350A and one of the four slave bodies 340A.

In addition, the assembly apparatus 300B in FIG. 12 can also be used to build the methane (CH₄) molecule; in contrast, the master light-emitting device 354 and the slave light-emitting device 344 will not emit light until the four connecting devices 320 are all used to connect the four slave bodies to the master body 350B since the master sockets 352 of the master body 350B are connected to the master light-emitting device 354 and the power supply 360 in series.

FIG. 16 illustrates one application of the assembly apparatus 300A, 300C and 300D according to one embodiment of the present invention. A urea (CO(NH₂)₂) molecule 400B is built by engaging six connecting devices 320, one connecting device 310A, one connecting device 310B, one master body 350C, four slave bodies 340A, two slave bodies 340B, and one slave body 340C. The master body 350C represents the carbon atom, the two slave bodies 340B represent the two nitrogen atoms, the slave body 340C represents the oxygen atom, the four slave bodies 340A represent the four hydrogen atoms, the connecting deceive 320A and the connecting device 310B represent the chemical bonds connecting the oxygen atom and the carbon atom, and the six connecting devices 320 represent the chemical bonds connecting the carbon atom, the nitrogen atom and the hydrogen atoms.

The above-described embodiments of the present invention are intended to be illustrative only. Numerous alternative embodiments may be devised by those skilled in the art without departing from the scope of the following claims.

What is claimed is:

1. An assembly apparatus of molecular model, comprising:
a connecting device including a first conductor, a second conductor and an isolation material configured to electrically isolate the first conductor from the second conductor, with the second conductor having a first plug, a second plug and a diode electrically connecting the first plug and the second plug;
a master body including a master socket configured to receive the first plug and a master light-emitting device electrically connected to the master socket; and
a slave body including a slave socket configured to receive the second plug and a slave light-emitting device electrically connected to the slave socket.

2. The assembly apparatus of molecular model of claim 1, wherein the first conductor is a conductive core.

3. The assembly apparatus of molecular model of claim 1, wherein the second conductor has a first conductive block connecting the first plug to one terminal of the diode and a second conductive block connecting the second plug to another terminal of the diode.

4. The assembly apparatus of molecular model of claim 3, wherein the first conductive block and the second conductive block are conductive shells.

5. The assembly apparatus of molecular model of claim 1, wherein the first plug and the second plug are screw bolts.

6. The assembly apparatus of molecular model of claim 1, wherein the master body includes a first conductive wire connecting the master socket to one end of the master light-emitting device.

7. The assembly apparatus of molecular model of claim 6, wherein the master body includes a conductive sheet configured to contact the first conductor of the connecting device when the master socket receives the first plug and a second conductive wire connecting the conductive sheet to another end of the master light-emitting device.

8. The assembly apparatus of molecular model of claim 1, wherein the master body includes a plurality of master sockets connected to the master light-emitting device in parallel.

9. The assembly apparatus of molecular model of claim 1, wherein the master body includes a plurality of master sockets connected to the master light-emitting device in series.

10. The assembly apparatus of molecular model of claim 1, wherein the master body includes a first master socket connected to the master light-emitting device in parallel and a plurality of second master sockets connected to the master light-emitting device in series.

11. The assembly apparatus of molecular model of claim 1, wherein the master body includes a power supply electrically connected to the master light-emitting device.

12. The assembly apparatus of molecular model of claim 1, wherein the slave body includes a first conductive wire connecting the slave socket to one end of the slave light-emitting device.

13. The assembly apparatus of molecular model of claim 12, wherein the slave body includes a conductive sheet configured to contact the first conductor of the connecting device when the slave socket receives the second plug, and a second conductive wire connecting the conductive sheet to another end of the slave light-emitting device.

14. The assembly apparatus of molecular model of claim 1, wherein the slave body includes a plurality of slave sockets connected to the slave light-emitting device in parallel.

15. The assembly apparatus of molecular model of claim 1, wherein the slave body includes a plurality of slave sockets connected to the master light-emitting device in series.
